(19) United States
(12) Patent Application Publication
(10) Pub. No.: US 2025/0260963 A1
(43) Pub. Date: Aug. 14, 2025

(54) METHOD AND APPARATUS FOR OBTAINING EMERGENCY SERVICE IN TELECOMMUNICATION SYSTEM

(71) Applicant: SAMSUNG ELECTRONICS CO., LTD., Suwon-si, Gyeonggi-do (KR)

(72) Inventors: Mahmoud WATFA, Staines, Middlesex (GB); Lalith KUMAR, Bangalore (IN); Erik GUTTMAN, Staines, Middlesex (GB)

(21) Appl. No.: 18/862,130

(22) PCT Filed: May 4, 2023
(86) PCT No.: PCT/KR2023/006137

§ 371 Date: Oct. 31, 2024

(30) Foreign Application Priority Data
May 4, 2022 (IN) 202231026011
May 3, 2023 (GB) 2306497.5

(51) Int. Cl. H04W 4/90; H04L 47/12; H04W 84/04

(52) U.S. Cl. CPC H04W 4/90; H04L 47/12; H04W 84/042

(57) ABSTRACT

The disclosure relates to a 5G or 6G communication system for supporting a higher data transmission rate. Disclosed is a method of operating a User Equipment, UE. The method includes identifying that a timer associated with requesting Disaster Roaming, DR is running, attempting to make an emergency call, and registering for emergency services.

### TECHNICAL FIELD

The present disclosure relates to handling of an emergency communication in a telecommunication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service arca expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to the handling of an emergency communication, such as a call to an emergency service from a mobile telephone or User Equipment, UE, from a cellular telecommunication system during a time when an associated network is afflicted with a disaster situation.

Aspects of the disclosure are to address at least the above-mentioned problems and/or disadvantages and to provide at least the advantages described below. Accordingly, an aspect of the disclosure is to provide an apparatus for managing cache loss caused by device reset and an operation method thereof.

Additional aspects will be set forth in part in the description which follows and, in part, will be apparent from the description, or may be learned by practice of the presented embodiments.

### Solution to Problem

In accordance with an aspect of the disclosure, a method of operating a user equipment, UE, is disclosed. The method may includes identifying that a timer associated with requesting disaster roaming, DR is running, attempting to make an emergency call, and registering for emergency services.

In accordance with an aspect of the disclosure, an user equipment, UE, comprising a transceiver and a processor is disclosed. The processor may be configured to identify that a timer associated with requesting disaster roaming, DR, is running, attempt to make an emergency call, and register for emergency services.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 shows architecture of a 5-th generation (5G) system including an user equipment (UE) according to an embodiment of the disclosure;

FIG. 2 shows a flow chart of a method according to an embodiment of the disclosure; and

FIG. 3 shows a block diagram of a UE according to an embodiment of the disclosure.

Throughout the drawings, like reference numerals will be understood to refer to like parts, components, and structures.

### MODE FOR THE INVENTION

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As used herein, cach of such phrases as “A or B”, “at least one of A and B”, “at least one of A or B”, “A, B, or C”, “at least one of A, B, and C” and “at least one of A, B, or C” may include all possible combinations of the items enumerated together in a corresponding one of the phrases. As used herein, such terms as “1st” and “2nd” or “first” and “second” may be used to simply distinguish a corresponding component from another, and does not limit the components in other aspect (e.g., importance or order).

In the disclosure, the user equipment (UE) may refer to a terminal, MS (mobile station), cellular phone, smartphone, computer, or various electronic devices capable of performing communication functions. According to the disclosure, the base station may be an entity allocating a resource to the UE and may be at least one of a gNode B, gNB, eNode B, cNB, Node B, BS, radio access network (RAN), base station controller, or node on network. \

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one clement from another.

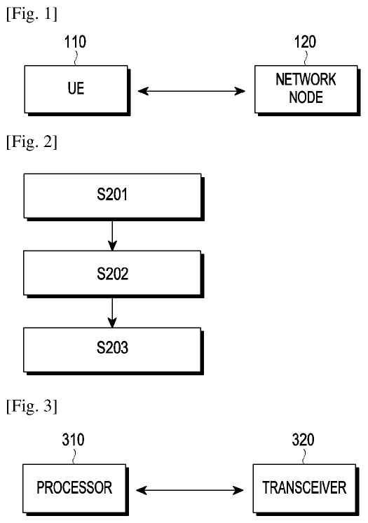

FIG. 1 shows architecture of a 5-th generation (5G) system including an user equipment (UE) according to an embodiment of the disclosure.

Referring to FIG. 1, 5G system includes an UE 110 and at least one network node 120. In an example, the at least one network node 120 comprises a base station (e.g., a NR node B (gNB)), and/or one or more core network entities (e.g., a network function (NF)). The UE 110 may use communication services via the at least one network node 120.

3GPP working groups have developed solutions to enable a UE (e.g., the UE 110) to get service even when a disaster condition (e.g. fire, etc) occurs on a public land mobile network, PLMN. In this case, the UE may be said to obtain disaster roaming service on a forbidden PLMN when no other PLMN is available. In other words, the UE is permitted to temporarily register with a PLMN which would ordinarily be unavailable or forbidden, for a period including the declared disaster.

The UE may start a timer, referred to as a disaster roaming wait range, which controls when the UE actually registers to the network to obtain so called disaster roaming service, sec 3GPP TS 24.501. The disaster roaming wait range may be intended to spread UE access to the target PLMN so as to avoid congestion. The disaster roaming wait range may be provisioned by the network.

The following is described in 3GPP TS 24.501 about the wait range:

Upon selecting a PLMN for disaster roaming as specified in 3GPP TS 23.122:
a) if the UE does not have a stored disaster roaming wait range, the UE may perform a registration procedure for disaster roaming services on the selected PLMN as described in clause 5.5.1; and
b) if the UE has a stored disaster roaming wait range, the UE may generate a random number within the disaster roaming wait range and start a timer with the generated random number. While the timer is running, the UE may not initiate registration on the selected PLMN. Upon expiration of the timer, the UE may perform a registration procedure for disaster roaming services as described in clause 5.5.1 if still camped on the selected PLMN.

As can be seen, it is clearly stated that “While the timer is running, the UE may not initiate registration on the selected PLMN”.

However, a problem with such an arrangement is that the UE may have a request for emergency services, (which is a high priority service where delays may be extremely undesirable or even dangerous), when the wait timer is running and the procedure set out in the prior art, referred to above, does not enable access to emergency services. As such, the user will be placed in a highly undesirable situation where they will not be able to access emergency services. Such a delay us highly undesirable.

The UE which is waiting to register for disaster roaming service which, by definition, would be with an otherwise forbidden PLMN, will be in a limited service state. The network normally broadcasts whether it accepts UEs in a limited state to obtain emergency services by performing an emergency registration.

Assuming that the network does indicate that limited state UEs can indeed obtain emergency services, then the UE which needs to place an emergency call but has a running wait timer will not be able to do so due to the explicit requirement that while the timer is running, the UE may not initiate registration on the selected PLMN (as set out above). This requirement can lead to problems, since the user expects to get emergency service, whereas the UE will not initiate the procedure, due to the wait timer, which is active and running.

It is an aim of an embodiment of the present disclosure to address this issue and permit the user to gain access to emergency services in such a scenario.

According to the present disclosure, there is provided an apparatus and method as set forth in the appended claims. Other features of the disclosure will be apparent from the dependent claims, and the description which follows.

According to a first aspect of the present disclosure, there is provided a method of operating a User Equipment, UE, wherein if the UE has an active timer, associated with requesting Disaster Roaming, DR, from a network, and the UE attempts to make an emergency call, then the UE registers for emergency services.

In an embodiment, registering for emergency services includes registering to use or establishing a Protocol Data Unit, PDU, session for emergency services.

In an embodiment, the UE maintains the active timer, even after registering for emergency services.

In an embodiment, if the active timer expires while the UE has an active emergency call or a Protocol Data Unit, PDU, session for emergency services, then the UE performs a registration procedure for DR, after the emergency call or the PDU session ends.

In an embodiment, the timer is started with a random number and is arranged to prevent congestion on the network.

According to a second aspect of the present disclosure, there is provided apparatus arranged to perform the method of the first aspect.

In an embodiment, the apparatus of claim 6 comprises a UE.

Although a few preferred embodiments of the present disclosure have been shown and described, it will be appreciated by those skilled in the art that various changes and modifications might be made without departing from the scope of the disclosure, as defined in the appended claims.

For a better understanding of the disclosure, and to show how embodiments of the same may be carried into effect, reference will now be made, by way of example only, to the accompanying diagrammatic drawings in which:

In an embodiment, a UE with a running wait time may attempt to register when there is a need to use an emergency PDU session.

Note that the following details apply for the case when the UE has received broadcast or system information indicating that the cell or PLMN supports emergency services, or IP Multimedia Core Network. Subsystem, IMS, emergency services, or Protocol Data Unit, PDU, session for emergency services, or eCall, optionally for a UE in limited service state (e.g. in 5GMM-REGISTERED.LIMITED-SERVICE or in state 5GMM-DEREGISTERED.LIMITED-SERVICE state).

When a UE with a running timer, which was started with a generated random number within the disaster roaming wait range, needs to request emergency services, or needs to use/establish a PDU session for emergency services, then the UE may initiate a registration procedure for emergency services i.e. the UE may send a Registration Request with the 5GS registration type Information Element, IE, set to “emergency registration”. Furthermore, the UE may keep the timer running (i.e. the disaster roaming wait range timer).

In other words, if the UE has a running timer which was started with a generated random number within the disaster roaming wait range (or if the timer is running), and/or the UE needs to establish a PDU session for emergency services, then the UE initiates the registration procedure and sets the 5GS registration type IE to “emergency registration” in the REGISTRATION REQUEST message. The UE keeps the timer running (or the UE does not stop the timer).

Optionally, the UE behaves as described above after having selected a PLMN for disaster roaming as specified in 3GPP TS 23.122.

When the UE registers for emergency service and establishes a PDU session for emergency service, the timer (which was started with a generated random number within the disaster roaming wait range) may expire while the UE's PDU session for emergency services is still active.

When this happens, the UE may behave in any of the following ways:
1. the UE may perform a registration procedure with the same PLMN, where the registration is for disaster roaming service. In this case, the UE sets the 5GS registration type IE to “disaster roaming mobility registration updating”, or to “disaster roaming initial registration”, in the REGISTRATION REQUESOT message. This may be performed while the PDU session for emergency service is still active (i.e. while it has not been released)
2. the UE may perform a registration procedure for disaster roaming only after it finishes the emergency service, or only after the emergency service ends e.g. after the PDU session for emergency service is released. In one option, the UE may perform a registration procedure for disaster roaming when it deregisters from the network, where for example the UE deregisters after the PDU session for emergency service is released
a. In this alternative, the UE may set the 5GS registration type IE to “disaster roaming mobility registration updating”, or to “disaster roaming initial registration”, in the REGISTRATION REQUEST message.

Note: the UE behaves as described above when the UE is in 5GMM-CONNECTED mode, or 5GMM-CONNECTED mode with RRC inactive indication, or in 5GMM-IDLE mode.

Further, if the UE registers for emergency services and completes the emergency service before the timer expires, the UE maintains the timer (i.e. the UE keeps the timer running) until it expires and then the UE registers for disaster roaming service.

The procedures set out above may be applied in any order and in any combination.

The following is an example text that may be proposed for 3GPP TS 24.501 standard specification, in accordance with an embodiment of the disclosure described herein:

“Upon selecting a PLMN for disaster roaming, if:
a) the timer is running as describe above; and
b) the UE needs to request a PDU session for emergency services;
the UE may initiate the registration procedure and set the 5GS registration type IE to “emergency registration” in the REGISTRATION REQUEST message. The UE keeps the timer running.

If the timer expires while the UE is registered for emergency services, the UE may perform the registration procedure and set the 5GS registration type IE to “disaster roaming mobility registration updating” in the REGISTRATION REQUEST message.”.

In an alternative embodiment, the UE may make an exception to the prior art requirement and perform a registration procedure for disaster roaming service even when the timer is running. As such, in this embodiment, the UE initiates the registration procedure and sets the 5GS registration type IE to “disaster roaming mobility registration updating”, or to “disaster roaming initial registration”, in the REGISTRATION REQUEST message. The UE may stop the timer after it has successfully registered in this case.

FIG. 2 shows a representation of a method according to an embodiment of the disclosure.

Referring to FIG. 2, at operation S201, the UE (e.g., the UE 110) may begin a timer. The timer may be to stagger DR requests in the event that a plurality of UEs attempt to register with another (non-home) network in the event of a disaster affecting the home network.

At operation S202, with the timer running, the UE may attempt an emergency call (including an emergency PDU session). At operation S203, the UE may maintain the timer.

According to an embodiment of the disclosure, a UE may be able to place an emergency call even while a timer for staggering/delaying access to a network offering DR is running. This ensures that an emergency call can be placed in circumstances where the prior art might have prohibited this or otherwise adversely affected it.

FIG. 3 shows a block diagram of a UE according to an embodiment of the disclosure.

Referring to FIG. 3, the UE (e.g., the UE 110) may include a processor 320, and a transceiver 320. In the embodiments in the present disclosure, the processor 310 may include at least one circuit, an application specific integrated circuit (ASIC), or at least one processing circuitry.

The transceiver 320 may transmit and receive signals to and from a external device (e.g., the network node 120).

The processor 310 may control the overall operation of the UE according to the embodiments of the disclosure. For example, the processor 310 may be configured to perform at least one of the embodiments described above. In an embodiment, the processor 310 may begin a timer. The timer may be to stagger DR requests in the event that a plurality of UEs attempt to register with another (non-home) network in the event of a disaster affecting the home network. In an embodiment, with the timer running, the processor 310 may attempt an emergency call (including an emergency PDU session). In an embodiment, the processor 310 may maintain the timer.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1. A method of operating a user equipment, UE, the method comprising:
identifying that a timer associated with requesting disaster roaming, DR is running;
attempting to make an emergency call; and
registering for emergency services.

2. The method of claim 1, wherein registering for emergency services comprises registering to use or establishing a protocol data unit, PDU, session for emergency services.

3. The method of claim 1, further comprising:
maintaining the timer running, even after registering for emergency services.

4. The method of claim 1, further comprising:
if the timer expires while the UE has an emergency call or a protocol data unit, PDU, session for emergency services, performing a registration procedure for DR, after release of the emergency call or the PDU session.

5. The method of claim 4, wherein, after the release of the emergency call or the PDU session, the UE is still camped on the selected public land mobile network, PLMN, for disaster roaming.

6. The method of claim 4, further comprising:
if the UE does not the emergency call or the PDU session upon expiration of the timer, performing a registration procedure for disaster roaming services.

7. The method of claim 1, wherein the timer is started with a random number and is arranged to prevent congestion on the network.

8. The method of claim 1, wherein, when the UE has a stored disaster roaming wait range upon selecting a PLMN for disaster roaming, the timer is started with a random number with the disaster roaming wait range.

9. An user equipment, UE, comprising a transceiver and a processor, wherein the processor is configured to:
identify that a timer associated with requesting disaster roaming, DR, is running,
attempt to make an emergency call, and
register for emergency services.

10. The UE of claim 9, wherein the processor is further configured to register to use or establishing a protocol data unit, PDU, session for emergency services.

11. The UE of claim 9, wherein the processor is further configured to:
maintain the timer running, even after registering for emergency services.

12. The UE of claim 9, wherein the processor is further configured to:
if the timer expires while the UE has an emergency call or a protocol data unit, PDU, session for emergency services, perform a registration procedure for DR, after the release of the emergency call or the PDU session.

13. The UE of claim 12, wherein, after the release of the emergency call or the PDU session, the UE is still camped on the selected PLMN for disaster roaming, and
wherein, if the UE does not the emergency call or the PDU session upon expiration of the timer, the UE performs a registration procedure for disaster roaming services.

14. The UE of claim 9, wherein the timer is started with a random number and is arranged to prevent congestion on the network.

15. The UE of claim 9, wherein, when the UE has a stored disaster roaming wait range upon selecting a PLMN for disaster roaming, the timer is started with a random number with the disaster roaming wait range.
